(19) United States
(12) Patent Application Publication
(10) Pub. No.: US 2013/0084450 A1
(43) Pub. Date: Apr. 4, 2013

(54) CORROSION RESISTANT MEMBER AND METHOD FOR MANUFACTURING THE SAME

(71) Applicants: Yukitaka MURATA, Aichi (JP); Hitoshi SASAKI, Aichi (JP); Shintaro MATSUMOTO, Aichi (JP)

(72) Inventors: Yukitaka MURATA, Aichi (JP); Hitoshi SASAKI, Aichi (JP); Shintaro MATSUMOTO, Aichi (JP)

(73) Assignee: Covalent Materials Corporation, Tokyo (JP)

(21) Appl. No.: 13/607,257

(22) Filed: Sep. 7, 2012

(30) Foreign Application Priority Data
Sep. 30, 2011 (JP) 2011-217772

(51) Int. Cl. B32B 3/26; B32B 18/00; C23C 4/10; B32B 15/04

(52) U.S. Cl. 428/304.4; 428/472; 428/450; 427/453

(57) ABSTRACT

The present invention relates to a corrosion resistant member including: a substrate composed of a ceramic or a metal, and at least one layer of a corrosion resistant film formed on a surface of at least a region of the substrate to be exposed to plasma or a corrosive gas, in which the corrosion resistant film contains yttria as a main component and further also contains at least one of tantalum and niobium in an amount of 0.02 to 10 mol % in terms of pentoxide relative to the yttria, and a non-melted portion is not present in the corrosion resistant film.

### FIELD OF THE INVENTION

The present invention relates to a corrosion resistant member which can be suitably used in a plasma treatment apparatus for manufacturing semiconductors, liquid crystal display parts, and the like and to a method for manufacturing the corrosion resistant member.

### BACKGROUND OF THE INVENTION

Hitherto, as parts for a plasma treatment apparatus for manufacturing semiconductors, liquid crystal display parts, and the like, alumina ceramics and yttria ceramics have been used but, in the case of a large-sized member, it is difficult to manufacture it as a sintered body.

Therefore, also in view of costs, there has been adopted a method of forming a film of alumina or yttria by a method such as spraying or the like only on the region where corrosion resistance is required at the plasma treatment.

Such a sprayed film preferably does not contain impurities so that an article to be treated in the plasma treatment apparatus is not contaminated. From such a viewpoint, in the spraying of yttria, hitherto, yttria alone has been used singly as a material for the spraying,

However, the sprayed film composed of yttria alone is difficult to densify and is formed in a state that the film contains pores with a porosity of about 3 to 5%. When the film contains many pores, it is easily etched from a pore portion at the plasma treatment and the etching causes generation of particles and also decreases corrosion resistance against plasma or a corrosive gas, so that there is a problem that the sprayed film is less durable.

Against the above problem, it has been proposed to form not the film of yttria alone but a film of a mixture thereof with another material. For example, Patent Document 1 describes an improvement in plasma resistance by forming a protective layer for an electrostatic chuck as the constitution containing yttria mixed with a metal such as aluminum, magnesium, titanium, or tantalum.

However, in the protective layer described in Patent Document 1, since the material to be mixed with yttria is a metal such as tantalum, there is a concern that the metal component gets mixed into an article to be treated, such as a wafer, in the plasma treatment apparatus as an impurity and thus contaminates the article to be treated.

Moreover, since the melting point of metal tantalum is about 3000° C. and is higher than 2430° C. that is the melting point of yttria, in the case where a film is formed by spraying or the like with mixing tantalum with yttria, the film surface is not sufficiently densified and is difficult to make in a state that pores and unevenness which may cause the generation of particles are not present.

Therefore, for the corrosion resistant film to be formed on members of the plasma treatment apparatus, it is required that the corrosion resistant film not only contains few impurities but also has few pores and little unevenness which may cause the generation of particles as well as is dense and has a smooth surface.

[Patent Document 1] JP-A-2008-42197

### SUMMARY OF THE INVENTION

The present invention is devised for solving the above technical problems and an object thereof is to provide a corrosion resistant member coated with a film composed of yttria as a main component, the member being capable of being used as a member of a plasma treatment apparatus for manufacturing semiconductors, liquid crystal display parts, and the like, being dense and having a smooth surface, not contaminating an article to be treated through generation of particles and metal impurities at plasma treatment, and being excellent in strength and durability, and a method for manufacturing the corrosion resistant member.

The invention relates to a corrosion resistant member comprising: a substrate composed of a ceramic or a metal, and at least one layer of a corrosion resistant film formed on a surface of at least a region of the substrate to be exposed to plasma or a corrosive gas,

wherein the corrosion resistant film contains yttria as a main component and further also contains at least one of tantalum and niobium in an amount of 0.02 to 10 mol % in terms of pentoxide relative to the yttria, and a non-melted portion is not present in the corrosion resistant film.

### DETAILED DESCRIPTION OF THE INVENTION

Here, the non-melted portion means a portion where yttria is not completely melted and a carcass thereof is present in a particle state in the above corrosion resistant film.

Since the yttria film in a state that such a non-melted portion is not present is dense and has a smooth surface and functions as an excellent corrosion resistant film and also an improvement in strength is achieved, the contamination of the article to be treated through the generation of particles and metal impurities can be suppressed in the case where the corrosion resistant member is applied to the plasma treatment apparatus.

In the corrosion resistant film, all amount of a tantalum oxide and/or a niobium oxide contained is preferably dissolved in yttria.

By forming the corrosion resistant film as a solid solution in a homogeneous state as a whole, the corrosion resistance can be further improved.

Also, the corrosion resistant film is preferably a sprayed film.

In order to form such a corrosion resistant film composed of a metal oxide material having a high melting point homogeneously and easily, it is preferred to form it as a sprayed film

Moreover, the corrosion resistant film preferably has a thickness of 5 to 1000 μm and at least a surface layer thereof has a porosity of 2.0% or less.

By forming the corrosion resistant film having thickness and porosity within the above ranges, it is achieved to suppress the generation of particles and improve the corrosion resistance and durability at the time when the corrosion resistant member is exposed to plasma or a corrosive gas.

Also, a method for manufacturing the corrosion resistant member of the present invention, the method comprising: mixing a raw material powder of yttria with a raw material powder of at least one of a tantalum oxide and a niobium oxide, followed by granulating the raw material powders to obtain a granulated powder; and spraying the granulated powder on the surface of a substrate composed of a ceramic or a metal by gas plasma spraying to form the corrosion resistant film.

By such gas plasma spraying, a dense and homogeneous high-quality corrosion resistant film can be formed.

In the method for manufacturing the corrosion resistant member, 50% particle diameter D₅₀ of the raw material powder of at least one of the tantalum oxide and niobium oxide preferably accounts for 10 to 80% relative to 50% particle diameter D₅₀ of the raw material powder of yttria.

Here, the 50% particle diameter D₅₀ is a particle diameter at 50% accumulation and is so-called median diameter,

By controlling the raw material powder to the particle size as mentioned above, a corrosion resistant film in a state that all the amount of the tantalum oxide and niobium oxide are dissolved in yttria can be suitably formed.

According to the corrosion resistant member of the invention, since a dense corrosion resistant film having a smooth surface is formed, the generation of particles and metal impurities is suppressed in the case where the film is exposed to plasma or a corrosive gas and also an improvement in strength and durability is achieved.

Therefore, the corrosion resistant member of the invention can be suitably applied mainly as a member of a plasma treatment apparatus for manufacturing semiconductors, liquid crystal display parts, and the like and impurity contamination of an article to be treated at the plasma treatment can be suppressed.

Moreover, according to the manufacturing method of the invention, the corrosion resistant member as mentioned above can be suitably manufactured.

The following will describe the invention in further detail.

The corrosion resistant member of the invention is the member comprising: a substrate composed of a ceramic or a metal, and at least one layer of a corrosion resistant film formed on a surface of at least a region of the substrate to be exposed to plasma or a corrosive gas, wherein the corrosion resistant film contains yttria as a main component and further also contains at least one of tantalum and niobium in an amount of 0.02 to 10 mol % in terms of pentoxide relative to the yttria, and a non-melted portion is not present in the corrosion resistant film.

By adding a metal oxide as mentioned above to yttria and achieving a state that the non-melted portion is not present, a corrosion resistant film having a dense and smooth surface can be obtained.

As the composition of the above corrosion resistant film, the corrosion resistant film contains yttria as a main component and further also contains at least one of tantalum oxide and niobium oxide in an amount of 0.02 to 10 mol % in terms of pentoxide relative to the yttria.

Among tantalum oxides and niobium oxides, a stable oxide is tantalum pentoxide or niobium pentoxide. The melting point of tantalum pentoxide is about 1880° C. and the melting point of niobium pentoxide is about 1520° C. Since the melting points are lower than about 2430° C. that is the melting point of yttria, both oxides play a role of lowering the melting point of the mixture containing yttria as a main component and accelerating densification of the film.

Moreover, since the above tantalum pentoxide or niobium pentoxide forms a solid solution or a composite oxide with yttria to be stabilized, in the case where they are exposed to plasma or a corrosive gas, the generation of impurities of metal simple substance of tantalum or niobium is suppressed and also the corrosion resistance against plasma or a corrosive gas, which yttria itself inherently has, is not impaired.

Therefore, the above tantalum oxide or niobium oxide is preferably tantalum pentoxide or niobium pentoxide.

In the above composition of the above corrosion resistant film, the tantalum oxide or niobium oxide contained in the corrosion resistant film may be either of them or both of them may be mixed.

The content of the tantalum oxide and/or niobium oxide is 0.02 mol % to 10 mol % in total in terms of pentoxide relative to yttria that is a main component of the composition.

When the content is less than 0.02 mol %, the aforementioned effect of lowering the melting point is insufficient and the effect of densifying the corrosion resistant film is not sufficiently obtained. On the other hand, when the content exceeds 10 mol %, the tantalum oxide or niobium oxide becomes excessive and impurities derived from tantalum or niobium are prone to be generated at the exposure to plasma or a corrosive gas.

The content of the tantalum oxide and/or niobium oxide is preferably 0.5 to 5 mol %.

Moreover, the non-melted portion is not present in the corrosion resistant film.

In the case where the non-melted portion is present in the corrosion resistant film, yttria is not completely melted and present in a particle state at the portion and voids are also present around the particles, so that a dense film is not formed and a decrease in strength of the corrosion resistant film is invited.

Therefore, the corrosion resistant film is to be formed in a completely melted state from the viewpoint of improving the strength.

The corrosion resistant film is in a state that the non-melted portion is not present as mentioned above and furthermore, all the amount of the tantalum oxide and/or niobium oxide contained is preferably dissolved in yttria.

In this regard, the phrase “all amount of a tantalum oxide and/or a niobium oxide contained is dissolved in yttria” means that any peaks originated from Ta of metal Ta, a Ta single phase, and the like are not present at the time when the film is subjected to X-ray diffraction (XRD).

Owing to the state that the corrosion resistant film is composed of a solid solution and is homogeneous as a whole, the corrosion resistance against plasma or a corrosive gas can be further improved.

The corrosion resistant film as mentioned above is preferably a sprayed film.

When the film is a sprayed film, the corrosion resistant film composed of the metal oxide material having a high melting point can be homogeneously and easily formed even on a substrate surface or the like having a complex shape.

Moreover, the corrosion resistant film preferably has a thickness of 5 to 1000 μm.

Within the above range, a sufficient corrosion resistance is obtained without exposure of the substrate even when the corrosion resistant member is exposed to plasma or a corrosive gas for a long period of time, and a member excellent in durability is obtained. Moreover, a sufficient bonding strength with the substrate is obtained and peel-off of the corrosion resistant film does not easily occur.

The corrosion resistant film more preferably has a thickness of 50 to 500 μm.

Moreover, at least a surface layer of the corrosion resistant film preferably has a porosity of 2.0% or less.

When the porosity is 2.0% or less, the progress of the etching originated from the pores is not accelerated and the generation of particles can be suppressed at the time when the corrosion resistant member is exposed to plasma or a corrosive gas.

As respective raw materials of yttria, the tantalum oxide, and the niobium oxide that are components of the corrosion resistant film, it is preferred to use highly pure powders having a purity of 99% or more in all eases.

When the purity is 99% or more, the generation of particles and contaminants originated from impurities in these raw materials can be suppressed at the time when the corrosion resistant member is exposed to plasma or a corrosive gas.

The material of the substrate to be coated with the corrosion resistant film is not particularly limited as long as it is ceramic or a metal. In the case where the corrosion resistant member is used in the plasma treatment apparatus for manufacturing semiconductors, liquid crystal display parts, and the like, for example, aluminum (including anodized aluminum), quarts, alumina, silicon carbide, silicon, or the like is used.

The corrosion resistant member of the invention as mentioned above is preferably manufactured by the method comprising: mixing a raw material powder of yttria with a raw material powder of at least one of a tantalum oxide and a niobium oxide, followed by granulating the raw material powders to obtain a granulated powder; and spraying the granulated powder on the surface of a substrate composed of a ceramic or a metal by gas plasma spraying to form the corrosion resistant film.

As methods for spraying, in general, there are flame spraying, plasma spraying, and the like. In the invention, it is preferred that mixing constitutional materials of the corrosion resistant film, followed by granulating the constitutional materials to obtain a powder for spraying, and forming the corrosion resistant film by plasma spraying.

Particularly, in the gas plasma spraying, since the power for spraying is sprayed with a plasma jet blast using an inert gas, the materials for composing the corrosion resistant film, such as yttria, can be sufficiently melted at a high temperature and collided to the substrate at a high speed as compared with the case of the flame spraying, so that a dense and homogeneous high-quality corrosion resistant film can be formed.

In the above manufacturing method, 50% particle diameter D₅₀ of the raw material powder of at least one of the tantalum oxide and niobium oxide preferably accounts for 10 to 80% relative to 50% particle diameter D₅₀ of the raw material powder of yttria.

In order to form the corrosion resistant film in a state that all the amount of the tantalum oxide and niobium oxide is dissolved in yttria, it is preferred to control respective particle sizes so that the 50% particle diameter D₅₀ of the tantalum oxide and niobium oxide and the 50% particle diameter D₅₀ of the raw material powder of yttria have the relation as mentioned above.

When D₅₀ of the tantalum oxide and niobium oxide is less than 10% of D₅₀ of the raw material powder of yttria, the powers are prone to separate and a homogeneous granulated powder is not obtained at the granulation step, so that segregation of the tantalum oxide or niobium oxide and the non-melted portion are prone to be generated in the sprayed film.

On the other hand, when D₅₀ of the tantalum oxide and niobium oxide exceeds 80% of D₅₀ of the raw material powder of yttria, coarse particles of the tantalum oxide do not easily form a complete solid solution with yttria and, also in this case, the segregation of the tantalum oxide or niobium oxide and the non-melted portion are prone to be generated in the sprayed film.

### EXAMPLE

The following will explain the invention further specifically based on Examples but the invention should not be construed as being limited to the following Examples.

Tantalum pentoxide (Ta₂O₅) or niobium pentoxide (Nb₂O₅) was added to an yttria powder having a raw material purity of 99.5% and, after spray granulation, the mixture was roasted at 1000° C. in the air. Using the obtained powder as a powder for spraying, a corrosion resistant film having a thickness of 200 μm is formed on a substrate surface of a plate-shaped aluminum of 100 mm×100 mm×thickness of 10 mm by a gas plasma spraying method, thereby manufacturing each sample of corrosion resistant members where the content of tantalum (Ta) or niobium (Nb) relative to yttria was the value shown in each of Examples and Comparative Examples in Table 1.

The content of Ta and/or Nb in each obtained sample was measured by ICP emission spectrochemical analysis and calculated in terms of pentoxide.

Incidentally, in Comparative Example 10, metal tantalum (Ta) was added to form a corrosion resistant film instead of adding Tantalum pentoxide or niobium pentoxide.

For each of the samples obtained in the above Examples and Comparative Examples, the porosity of the corrosion resistant film was measured by the area of pores in a 200-fold visual field of a sectional electron microscope (SEM) photograph.

The presence of the non-melted portion was investigated on SEM observation. The solid solution state of the tantalum oxide and niobium oxide was investigated by confirming the presence of segregation based on detection of peaks of Ta and Nb in X-ray diffraction.

Moreover, after a corrosion resistant film having a thickness of 5 mm was formed in the same manner as mentioned above on a substrate surface of a plate-shaped aluminum of 50 mm×40 mm×5 mm, the film was removed from the aluminum substrate to manufacture a test piece of the corrosion resistant film of 3 mm×4 mm×40 mm. Then, 4-point flexural strength was measured in accordance with JIS R 1601.

Moreover, a sprayed film was formed on an aluminum-made upper electrode in the same manner as mentioned above and, using the electrode, a silicon wafer having a diameter of 300 mm was subjected to plasma treatment in an RIE type etching apparatus (used gas: CF₄, O₂).

Thereafter, the number of particles having a size of 0.15 μm or more on the wafer was measured by means of a laser particle counter. Moreover, contamination of Ta, Nb, and the like on the wafer was detected and the amount of each element was measured on ICP-MS.

Respective measurement results of the above Examples and Comparative Examples are collectively shown in Table 1. In this regard, D₅₀ in Table 1 is a ratio of D₅₀ of the raw material powder of Ta₂O₅ and Nb₂O₅ to D₅₀ of the raw material powder of yttria.

TABLE 1

| | | | | | | Thickness of | | | | | | | |
|---|---|---|---|---|---|---|---|---|---|---|---|---|---|
| | Content (in terms of | | | | | corrosion | Non- | | Flexural | Particle | Contamination | | |
| | pentoxide (mol %) | | | D₅₀ | Porosity | resistant film | melted | | strength | number | (10¹¹ × atoms/cm²) | | |
| | Ta | Nb | Total | (%) | (%) | (μm) | portion | Segregation | (MPa) | (piece) | Ta | Nb | Y |
| Example 1 | 0.02 | 0 | 0.02 | 50 | 1.4 | 200 | absent | absent | 82 | 5 | 5 | — | 30 |
| Example 2 | 0.5 | 0 | 0.5 | 50 | 1.4 | 200 | absent | absent | 100 | 6 | 7 | — | 25 |
| Example 3 | 5 | 0 | 5 | 50 | 1.8 | 200 | absent | absent | 98 | 9 | 3 | — | 35 |
| Example 4 | 10 | 0 | 10 | 50 | 1.8 | 200 | absent | absent | 85 | 8 | 7 | — | 35 |
| Example 5 | 0 | 0.02 | 0.02 | 50 | 1.6 | 200 | absent | absent | 75 | 6 | — | 10 | 40 |
| Example 6 | 0 | 0.5 | 0.5 | 50 | 1.8 | 200 | absent | absent | 95 | 7 | — | 4 | 33 |
| Example 7 | 0 | 5 | 5 | 50 | 1.6 | 200 | absent | absent | 98 | 7 | — | 4 | 35 |
| Example 8 | 0 | 10 | 10 | 50 | 1.4 | 200 | absent | absent | 88 | 6 | — | 6 | 34 |
| Example 9 | 0.01 | 0.01 | 0.02 | 50 | 1.5 | 200 | absent | absent | 73 | 5 | 3 | 8 | 32 |
| Example 10 | 0.35 | 0.15 | 0.5 | 50 | 1.4 | 200 | absent | absent | 96 | 5 | 6 | 2 | 30 |
| Example 11 | 1.5 | 3.5 | 5 | 50 | 1.8 | 200 | absent | absent | 98 | 6 | 4 | 4 | 30 |
| Example 12 | 5 | 5 | 10 | 50 | 1.6 | 200 | absent | absent | 69 | 5 | 5 | 7 | 33 |
| Example 13 | 2 | 0.4 | 2.4 | 50 | 2.0 | 200 | absent | absent | 77 | 6 | 8 | 4 | 29 |
| Example 14 | 3 | 0.07 | 3.07 | 50 | 1.6 | 5 | absent | absent | 70 | 6 | 7 | 6 | 35 |
| Example 15 | 8 | 0.02 | 8.02 | 50 | 1.5 | 50 | absent | absent | 83 | 5 | 7 | 9 | 33 |
| Example 16 | 0.1 | 5 | 5.1 | 50 | 1.5 | 500 | absent | absent | 94 | 7 | 6 | 4 | 31 |
| Example 17 | 0.06 | 5 | 5.06 | 50 | 1.8 | 1000 | absent | absent | 78 | 5 | 5 | 5 | 35 |
| Example 18 | 3 | 3 | 6 | 50 | 3.0 | 200 | absent | absent | 65 | 15 | 6 | 6 | 31 |
| Example 19 | 3 | 3 | 6 | 50 | 1.6 | 3 | absent | absent | 82 | 10 | 8 | 8 | 35 |
| Example 20 | 3 | 3 | 6 | 50 | 1.6 | 2000 | absent | absent | 80 | 4 | 4 | 6 | 28 |
| Example 21 | 5 | 0 | 5 | 150 | 1.8 | 200 | absent | present | 80 | 18 | 13 | — | 35 |
| Example 22 | 0 | 5 | 5 | 150 | 1.7 | 200 | absent | present | 83 | 20 | — | 15 | 40 |
| Comparative | 0.01 | 0 | 0.01 | 50 | 1.6 | 200 | present | absent | 55 | 20 | 4 | — | 55 |
| Example 1 | | | | | | | | | | | | | |
| Comparative | 15 | 0 | 15 | 50 | 1.6 | 200 | absent | present | 70 | 7 | 20 | — | 30 |
| Example 2 | | | | | | | | | | | | | |
| Comparative | 0 | 0.01 | 0.01 | 50 | 1.6 | 200 | present | absent | 53 | 25 | — | 10 | 60 |
| Example 3 | | | | | | | | | | | | | |
| Comparative | 0 | 15 | 15 | 50 | 1.6 | 200 | absent | present | 73 | 8 | — | 30 | 35 |
| Example 4 | | | | | | | | | | | | | |
| Comparative | 0.005 | 0.005 | 0.01 | 50 | 1.6 | 200 | present | absent | 48 | 20 | 4 | 6 | 58 |
| Example 5 | | | | | | | | | | | | | |
| Comparative | 7.5 | 7.5 | 15 | 50 | 1.6 | 200 | absent | present | 70 | 9 | 20 | 30 | 30 |
| Example 6 | | | | | | | | | | | | | |
| Comparative | 0 | 0 | 0 | 50 | 3.5 | 200 | present | absent | 52 | 25 | — | — | 70 |
| Example 7 | | | | | | | | | | | | | |
| Comparative | 5 | 0 | 5 | 5 | 2.5 | 200 | present | present | 55 | 20 | 15 | — | 55 |
| Example 8 | | | | | | | | | | | | | |
| Comparative | 0 | 5 | 5 | 5 | 2.7 | 200 | present | present | 58 | 22 | — | 14 | 60 |
| Example 9 | | | | | | | | | | | | | |

| | | | | | | | | | | | | |
|---|---|---|---|---|---|---|---|---|---|---|---|---|
| Comparative | Ta | 0.5 | 50 | 3.8 | 200 | — | — | 55 | 20 | 30 | — | 65 |
| Example 10 | | | | | | | | | | | | |

As shown in Table 1, in the corrosion resistant member of Examples 1 to 22, the flexural strength was improved and particles on the wafers to be treated and metal contamination originated from the materials for composing the corrosion resistant films are few and little, so that it was observed that impurity contamination was suppressed.

In this regard, after the plasma treatment, in the case where the thickness of the corrosion resistant film is too thin (Example 19), a part of the substrate was exposed. On the other hand, in the case where the thickness of the corrosion resistant film is too thick (Example 20), peel-off occurred at a part of the corrosion resistant film.

While the invention has been described in detail with reference to specific embodiments thereof, it will be apparent to one skilled in the art that various changes and modifications can be made therein without departing from the spirit and scope thereof.

Incidentally, the present application is based on Japanese Patent Applications No. 2011-217772 filed on Sep. 30, 2011 and the contents are incorporated herein by reference.

What is claimed is:

1. A corrosion resistant member comprising:
a substrate composed of a ceramic or a metal, and
at least one layer of a corrosion resistant film formed on a surface of at least a region of the substrate to be exposed to plasma or a corrosive gas,
wherein the corrosion resistant film contains yttria as a main component and further also contains at least one of tantalum and niobium in an amount of 0.02 to 10 mol % in terms of pentoxide relative to the yttria, and a non-melted portion is not present in the corrosion resistant film.

2. The corrosion resistant member according to claim 1, wherein, in the corrosion resistant film, all amount of a tantalum oxide and/or a niobium oxide contained is dissolved in yttria.

3. The corrosion resistant member according to claim 1, wherein the corrosion resistant film is a sprayed film,

4. The corrosion resistant member according to claim 2, wherein the corrosion resistant film is a sprayed film.

5. The corrosion resistant member according to claim 1, wherein the corrosion resistant film has a thickness of 5 to 1000 μm and at least a surface layer thereof has a porosity of 2.0% or less.

6. The corrosion resistant member according to claim 2, wherein the corrosion resistant film has a thickness of 5 to 1000 μm and at least a surface layer thereof has a porosity of 2.0% or less.

7. The corrosion resistant member according to claim 3, wherein the corrosion resistant film has a thickness of 5 to 1000 μm and at least a surface layer thereof has a porosity of 2.0% or less.

8. A method for manufacturing the corrosion resistant member according to claim 1, the method comprising:
mixing a raw material powder of yttria with a raw material powder of at least one of a tantalum oxide and a niobium oxide, followed by granulating the raw material powders to obtain a granulated powder; and
spraying the granulated powder on the surface of a substrate composed of a ceramic or a metal by gas plasma spraying to form the corrosion resistant film.

9. The method for manufacturing the corrosion resistant member according to claim 8,
wherein 50% particle diameter D₅₀ of the raw material powder of at least one of the tantalum oxide and niobium oxide accounts for 10 to 80% relative to 50% particle diameter D₅₀ of the raw material powder of yttria.
